(19) United States
(12) Patent Application Publication
(10) Pub. No.: US 2026/0291079 A1
(43) Pub. Date: Sep. 24, 2026

(54) FEEDING STRUCTURE FOR A DUAL POLARIZED RADIATOR

(71) Applicant: Telefonaktiebolaget LM Ericsson (publ), Stockholm (SE)

(72) Inventors: Andreas Vollmer, Rosenheim (DE); Markus Mohr, Rosenheim (DE); Sertan Hastürkoglu, München (DE)

(21) Appl. No.: 19/127,720

(22) PCT Filed: Nov. 14, 2022
(86) PCT No.: PCT/EP2022/081849

§ 371 Date: May 6, 2025

(51) Int. Cl. H01Q 15/24; H01Q 1/24; H01Q 9/16

(52) U.S. Cl. CPC H01Q 15/24; H01Q 1/246; H01Q 9/16

(57) ABSTRACT

A feeding structure for a dual polarized radiator, a dual polarized radiator, particularly for a base station antenna and to a base station. The feeding structure comprises a first pair of balanced conductor elements being connected to a first radiator of a dual polarized radiator and a second pair of balanced conductor elements being connected to a second radiator of the dual polarized radiator. A first unbalanced conductor element is assigned the first pair of balanced conductor elements, so as to form a first Marchand balun and a second unbalanced conductor element is assigned the second pair of balanced conductor elements to form a second Marchand balun. Further, a slot is formed between the first pair and the second pair of balanced conductor elements, separating the first and second pairs of balanced conductor elements.

### FIELD OF THE INVENTION

The invention relates to a feeding structure for a dual polarized radiator, particularly for a base station antenna, a dual polarized radiator and a base station antenna for mobile communication.

### BACKGROUND

Base station antennas used for wireless communication base stations are typically composed of multiple radiators so as to enable radio frequency cellular communication with an improved transmission range and/or with distinct frequency bands. Such radiators may be formed as dual polarized radiators, such as dual polarized dipole radiators, which include two radiator arms (respectively dipole arms), each radiator arm requiring a respective feed line.

Feed lines may be realized on printed circuit boards (PCB) or in sheet metal. In order to provide a respective feed line for both dipole arms, a feeding structure is commonly formed of two (PCB) parts that are positioned such that the respective feed lines are in an orthogonal arrangement to each other. Examples of such feeding structures are described e.g. in WO 2018/224666 A1.

Nowadays, there is a trend towards each dual polarized radiator having only one planar feeding structure (e.g. a PCB). Having only one planar feeding structure for one dual polarized dipole results in lower costs and in a lower radiator footprint. The lower footprint is also essential for e.g. compact multiband antennas, as e.g. known from WO 2022 022 804 A1.

Such antennas may include at least three different interleaved and/or overlapping radiators, e.g. one in the frequency range from 698-969 MHz, one from 1427-2690 MHz and one from 3300-4200 MHz.

However, known feeding structures and antennas oftentimes reveal problems with far field pattern stability over frequency, matchability and/or transparency for further radiators.

The far field pattern variation over the frequency is typically higher for feeding structures, where a conductor of an unbalanced signal line is connected directly or capacitively to one dipole arm. For example, CN 114 122 718 A and CN 216 055 166 U, suggest connecting a signal line of a microstripline directly to a respective radiator arm. Further, undesired surface currents, such as jacket waves, can be an issue. Hence, additional parts have to be added, leading to an increased complexity and an increase of costs.

Hence, the object of the present disclosure is to provide an improved dual polarized radiator, and particularly an improved feeding structure for dual polarized radiators.

### SUMMARY

The object is achieved by a feeding structure according to claim 1, a dual polarized radiator according to claim 18 and a base station antenna according to claim 26. Further aspects of the present disclosure are given in the dependent claims.

In particular, the object is achieved by a feeding structure for a dual polarized radiator, particularly for a base station antenna. The feeding structure comprises a first conductive plane and a second conductive plane. Those planes may be arranged substantially parallel to each other, e.g. as conductive layers of a PCB. Further, at least one of the conductive planes may be provided as a sheet metal, being oriented substantially parallel to the further plane.

The first conductive plane comprises a first pair of balanced conductor elements and a second pair of balanced conductor elements. Particularly, the first pair of balanced conductor elements may include a first and second balanced conductor element, wherein first and second balanced conductor elements are separated by an insulating slot. Accordingly, the second pair of balanced conductor elements may include a first and second balanced conductor element, wherein first and second balanced conductor elements are separated by an insulating slot. The insulating slot may be filled or non-filled. In case of a filled insulating slot a (rigid or flexible) insulating material may be present in the slot. In case of a non-filled insulating slot, the slot may be an air gap.

The respective balanced conductor elements may be provided as conductive fingers, which run parallel to each other, at least in a partial section.

The first pair of balanced conductor elements provides a balanced output and is adapted to being connected to a first radiator of a dual polarized radiator with a first radiator connection end. Accordingly, the second pair of balanced conductor elements provides a balanced output and is adapted to being connected to a second radiator of the dual polarized radiator with a second radiator connection end. Particularly, the respective balanced conductor elements may be galvanically connected to corresponding arms (e.g. dipole arms) of radiators of the dual polarized radiator. The galvanic connection may be achieved by soldering (e.g. by a selective wave soldering method), welding (e.g. spot-welding), electrical plug connections, and/or the like.

It is to be understood, that the balanced conductor elements extend, particularly longitudinally, along the feeding structure to the respective radiator connection end.

The second conductive plane comprises a first unbalanced conductor element and a second unbalanced conductor element. The unbalanced conductor elements are not galvanically connected to any one of the balanced conductor elements.

Each one of the unbalanced conductor elements has a first branch and a second branch, wherein the second branch is conductively (i.e. galvanically) connected to the respective first branch at a feeding point of the feeding structure. Particularly, the first and second branch may be part of the same conductor path provided on a PCB. In another aspect, the first and second branch may be integrally formed by a stamped and/or bended metal sheet part, or by two metal sheet parts being fixed to each other (e.g. by pins, rivets, screws, soldering, welding, and/or the like).

The first branches of the unbalanced conductor elements are input branches, being adapted to being conductively connected to a respective unbalanced signal input line (e.g. a micro strip line or a coax-cable). The respective second branches are preferably open branches, each e.g. formed as open stub. In an alternative aspect, the second branches can be connected to ground.

The first branch of the first unbalanced conductor element is assigned to a first balanced conductor element of the first pair of balanced conductor elements and the second branch of the first unbalanced conductor element is assigned to a second balanced conductor element of the first pair of balanced conductor elements, so as to form a first Marchand balun assigned to the first pair of balanced conductor elements. Further, the first branch of the second unbalanced conductor element is assigned to a first balanced conductor element of the second pair of balanced conductor elements and the second branch of the second unbalanced conductor element is assigned to a second balanced conductor element of the second pair of balanced conductor elements, so as to form a second Marchand balun assigned to the second pair of balanced conductor elements.

For assigning the first/second branches to the respective balanced conductor elements, the branches and balanced conductor elements can be capacitively broadside coupled. Hence, the main area of the respective branches and balanced conductor elements overlap to allow for the coupling. Accordingly, the coupled branch and conductor element may have a common coupling region, wherein the respective coupled branch and conductor element have the same shape in this coupling region. In this case, branch and conductor element may be arranged congruently. Further, either one of the branch or the conductor element may have a larger cross section as the respective conductor element or branch. In this case, the smaller one may be fully aligned with the larger one. Alternatively, the coupled branch and conductor element may be arranged only partially overlapping.

For example, the first branch of the first unbalanced conductor element may extend along and overlap the first balanced conductor element of the first pair of balanced conductor elements, and/or the second branch of the first unbalanced conductor element may extend along and overlap the second balanced conductor element of the first pair of balanced conductor elements. Accordingly, the first branch of the second unbalanced conductor element may extend along and overlap the first balanced conductor element of the second pair of balanced conductor elements, and/or the second branch of the second unbalanced conductor element may extend along and overlap the second balanced conductor element of the second pair of balanced conductor elements.

As each of the unbalanced conductor elements is assigned to a respective pair of balanced conductor elements Marchand baluns are formed. Generally, a balun (balancing unit) is an electrical device that allows balanced and unbalanced lines to be interfaced without disturbing the impedance arrangement of either line. In other words, the balun assigned to each one of the pairs of balanced conductor elements transforms the unbalanced input signal, provided by the respective first and second unbalanced conductor elements to a balanced input signal, that is then transferred by the balanced conductor elements to the respective radiator.

The first branches of the first unbalanced conductor element and the second unbalanced conductor element may be arranged immediately side by side, or wherein the second branches of the first unbalanced conductor element and the second unbalanced conductor element may be arranged immediately side by side.

For example, the first balanced conductor element of the first pair of balanced conductor elements may have a phase shift of 0° and the second balanced conductor element of the first pair of balanced conductor elements may have a phase shift of 180°. Accordingly, the first balanced conductor element of the second pair of balanced conductor elements may have a phase shift of 0° and the second balanced conductor element of the second pair of balanced conductor elements may have a phase shift of 180°. Within the feeding structure, the balanced conductor elements may be arranged side by side, in the following order:
first conductive element (first pair)|second conductive element (first pair)|second conductive element (second pair)|first conductive element (second pair)

In this case, the second (open) branches of the first and second unbalanced conductor elements are arranged side by side and are sandwiched by the respective first branches.

Alternatively, the balanced conductor elements may be arranged side by side, in the following order:
second conductive element (first pair)|first conductive element (first pair)|first conductive element (second pair)|second conductive element (second pair) In this case, the first branches of the first and second unbalanced conductor elements are arranged side by side and are sandwiched by the respective second, open branches.

Between the first pair of balanced conductor elements and the second pair of balanced conductor elements a slot is formed. This slot extends from the first and/or second radiator connection end for separating the first and second pairs of balanced conductor elements at least along a portion of the length of the balanced conductor elements.

The above feeding structure tends to reach more stable patters over a wide frequency range, e.g. from 1427 to 2690 MHz, as the radiators (such as dipoles) are fed with balanced conductor elements, i.e. a balanced line (also called differential line). Moreover, as the radiators are fed with a Marchand balun the matching potential can be increased. This is inter alia, as the feeding point height is variable and the length of the second branches (open stub length) is variable.

Further, the feeding structure has a more symmetric pattern, due to its conductive structure and the position of respective interconnection points between the feeding structure and the two radiators to be fed.

Still further it has shown that by providing a slot between the first and second pair of balanced conductor elements a port to port isolation of at least 25 dB could be reached.

As explained above, the at least one of the first and/or second conductive planes may be a conductive plane of a PCB. Particular, the first and second conductive planes may be conductive planes of the same PCB. This allows for a feeding structure with a very small foot print. For example, the PCB may have a width of about 15 mm and a thickness of about 1 mm.

Further at least one of the first and/or second conductive planes may be a sheet metal plane. Particularly, at least one of the unbalanced conductor elements may be formed as sheet metal part(s). Here, the first and second branches of the unbalanced conductor elements may be integrally formed by a stamped and/or bended metal sheet part, or by two metal sheet parts (e.g. 2 parts, 3 parts, . . . ) being fixed to each other (e.g. by pins, rivets, screws, soldering, welding, and/or the like).

The first and second conductive planes may sandwich an insulator layer, wherein the first and second conductive layers may fixedly be adhered to the insulator layer. Thus, a rigid and reliable feeding structure can be provided.

Preferably, the highest point of the radiator is λ/4 over the reflector, more preferably less to achieve desired radiator far field characteristics.

Depending on the radiator design and feeding point position, the first branch and second branch may have together a length of λ/4 or at least one by oneself λ/4, wherein A denotes the wavelength of the dual polarized radiator to be fed.

In case of the second branches have a length of λ/4 from the feeding point to its open end (open stub length=λ/4), the open stub may be replaced by a short close to the feeding point 300.

The slot provided between the first and second pair or balanced conductor elements may extend from the first and/or second radiator connection end at least to the feeding point and may even pass the feeding point.

In a further aspect, this slot extends from the first and/or second radiator connection end at least along the length, particularly the entire length, of the first unbalanced conductor element and/or the second unbalanced conductor element. In this case, the balanced conductor elements may have a common base conductive part, connecting the balanced conductor elements of the first pair, the second pair, or the first and the second pair of balanced conductor elements. According to a further aspect, the slot may extend over the entire first conductive plane so as to separate the first and second pairs of balanced conductor elements balanced conductor elements balanced conductor elements. Particularly, the slot may separate the marchand baluns assigned to the first and second pairs of balanced conductor elements, resulting in port to port isolation values better than 25 dB.

Even further, the slot may extend through the entire feeding structure in a direction perpendicular to the first conductive plane. Thus, a non-filled slot can be provided.

For connecting the feeding structure to the respective radiators, the first radiator connection end and the second radiator connection end may be provided on opposing sides of a dual polarized radiator to be fed. In a further aspect, the first radiator connection end and the second radiator connection end are provided on the same side of the dual polarized radiator to be fed. Particularly, the first radiator connection end and the second radiator connection end may be arranged on a side of a dual polarized radiator that faces away from the feeding point. Hence, the first radiator connection end and the second radiator connection would be provided on an upper side of the dual polarized radiator allowing for an improved access to the respective connection ends. Accordingly, connecting is facilitated and can e.g. done by using a selective wave soldering method.

In a further aspect, at least one of the first and second pair of balanced conductor elements penetrates the radiator and extends over the radiator. Further, one of the first and second pair of balanced conductor elements may penetrate the radiator and may extend over the radiator more than the respective other pair of balanced conductor elements. Even further, the first pair of balanced conductor elements may extend more over the radiator while the second pair of balanced conductor elements may overlap in a vertical plane more than the first pair with the first radiator connection end and the second radiator connection end.

In a further aspect, no vias are provided in the unbalanced first and second conductor elements. Hence, no disturbances caused by vias occur. Moreover, the first or second balanced conductor element of the first pair of balanced conductor elements may include at least one via, so that this balanced conductor element of the first pair of conductor elements is partially arranged on the second conductive plane, at least at the first radiator connection end. Accordingly, the first or second balanced conductor element of the second pair of balanced conductor elements includes at least one via, so that this balanced conductor element of the second pair of conductor elements is partially arranged on the second conductive plane, at least at the second radiator connection end.

With providing a via/vias the respective balanced conductor element(s) may start on the first conductive plane and may then be continued on the second conductive plane. This allows to connect opposing arms of radiators easily, as the gap formed between these arms can be bridged by the via(s). In a particular example, the gap between two radiator arms of a radiator of a dual polarized radiator may be about the thickness of a PCB providing the feeding structure. The first conductive plane may be arranged on a first side of said PCB and the second conductive plane may be arranged on a second, opposing side of said PCB. In this case, the first balanced conductor element (e.g. of the first pair) may have no via and may be exclusively arranged on the first conductive plane. This first balanced conductor element may be connected to a first arm of the radiator. The second balanced conductor element may include a via/vias and accordingly may start on the first conductive plane and may be continued on the second conductive plane. The part of the second balanced conductor element arranged on the second conductive plane may then be connected to a second radiator arm of the radiator. Hence, the gap between the radiator arms can be bridged using a via/vias, allowing for a small footprint of the feeding structure. Likewise, the second pair may be connected to a second radiator.

At least one via, multiple vias or all vias assigned to one of the balanced conductor elements may be arranged on a side of the dual polarized radiator to be fed that faces the feeding point. Hence, the radiator connection ends can be provided with a smallest possible protrusion in case the first radiator connection end and the second radiator connection would be provided on an upper side of the dual polarized radiator. This facilitates the soldering/welding and prevents undesired disturbances of the radiation characteristic.

At least one of the balanced conductor elements of a respective pair of balanced conductor elements may include an electrical length compensation element and/or an additional overlap element. An electrical length extension element is an element that extends the length of the of the balanced conductor element. Hence, the radiator arms are not connected on the shortest possible way. Providing an electrical length extension element allows to compensate for length differences between the first and second pair of balanced conductor elements caused by the structural design of the radiator and/or the feeding structure. Thus, the balanced conductor elements can be provided with an (almost) identical electrical length of the current path to the radiator arms.

With providing an additional overlap element, i.e. a portion of a balanced conductor element overlaps (but is not electrically connected to) a further balanced conductor element (e.g. by edge coupling and/or broadside coupling), the phase shift between the conductor elements can be adjusted.

The object is further achieved by a dual polarized radiator including a feeding structure as described above. The dual polarized radiator further includes a first radiator, particularly a first dipole, and a second radiator, particularly a dipole, wherein the first radiator is conductively connected to the first pair of balanced conductor elements and wherein the second radiator is conductively connected to the second pair of balanced conductor elements.

The dual polarized radiator, particularly the first and second radiators may be PCB radiators or sheet metal radiators. PCB radiators are radiators formed on a PCB. Those PCB radiators allow for a cost efficient, precise and highly automated manufacturing. Further, a small footprint can be provided. Sheet metal radiators can be more reliable as they are generally less prone to undesired flexing.

Further, the dual polarized radiator may include a reflector, wherein the reflector may be assigned to further radiators. The feeding structure may penetrate the reflector. Accordingly, the reflector may include a respective through opening for receiving the feeding structure. In this aspect, the first unbalanced conductor element and a second unbalanced conductor element may be arranged on a side of the reflector facing away from the dual polarized radiator. Hence, the unbalanced signal lines, as well as the baluns, can stay underneath the reflector. Thus, the transparency of the feeding structure can be increased.

The first radiator may have a first radiator arm and a second radiator arm and the second radiator may have a first radiator arm and a second radiator arm, wherein the feeding structure may be centered between the first radiator arm and the second radiator arm of the first radiator and/or between the first radiator arm and the second radiator arm of the second radiator. This allows for an advantageously symmetric setup. Particularly, the first radiator arm and the second radiator arm of the first radiator and the first radiator arm and the second radiator arm of the second radiator may be in crossed arrangement relative to each other. Further, the first and or second radiator may be a linear polarized dipole, or a circular polarized dipole.

According to a further aspect, the first branches of the unbalanced conductor elements may be (directly) connected to respective micro strip lines or to a feed PCB. Thus, the footprint can be further reduced.

The object is further achieved by a base station antenna for wireless communication. The base station antenna includes at least one dual polarized radiator described above. Optionally, the base station antenna may include a phase shifter for adapting the beam direction of the base station antenna.

### BRIEF DESCRIPTION OF THE FIGURES

The present disclosure will be more readily appreciated by reference to the following detailed description when being considered in connection with the accompanying drawings in which:

FIG. 1 shows a schematic illustration of a dual polarized radiator, including a feeding structure;

FIG. 2A shows a schematic illustration of the feeding structure shown in FIG. 1;

FIG. 2B shows a schematic illustration of an alternative feeding structure;

FIG. 3 shows a schematic illustration of a further dual polarized radiator, including a further feeding structure;

FIG. 4 shows schematic details of the feeding structure shown in FIG. 3;

FIG. 5A shows schematic details of the feeding structure including a long slot;

FIG. 5B shows schematic details of the feeding structure including a short slot;

FIG. 5C shows schematic details of the feeding structure including no slot;

FIG. 5D shows a graph measured for the feeding structures according to FIGS. 5A to 5C;

FIG. 6A shows a schematic view of a dual polarized radiator including a reflector;

FIG. 6B shows a schematic side view of the dual polarized radiator of FIG. 6A, and

FIG. 7 shows a schematic illustration of a base station.

### DETAILED DESCRIPTION OF THE FIGURES

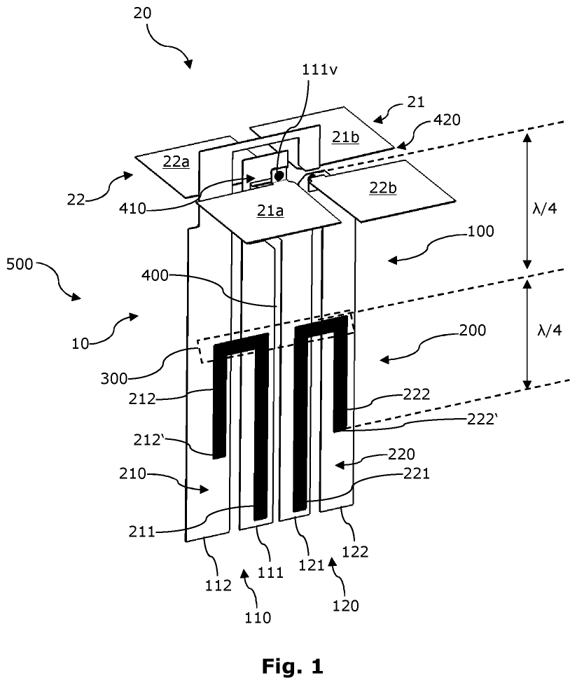

FIG. 1 shows a schematic illustration of a dual polarized radiator 20, including a feeding structure 10. The dual polarized radiator 20 includes a first radiator 21, being a dipole (e.g. linearly polarized) having a first radiator arm 21a and a second radiator arm 21b. Further, the dual polarized radiator 20 includes a second radiator 22, being a dipole (e.g. linearly polarized) having a first radiator arm 22a and a second radiator arm 22b Here, the first and second radiators 21, 22 are PCB radiators being arranged on the same PCB. It is to be understood, that the radiators could also be formed of e.g. sheet metal.

The first radiator arm 21a and a second radiator arm 21b of the first radiator 21 as well as the first radiator arm 22a and a second radiator arm 22b of the second radiator 22 are in crossed arrangement relative to each other, in this way realizing a dual linear polarized radiator.

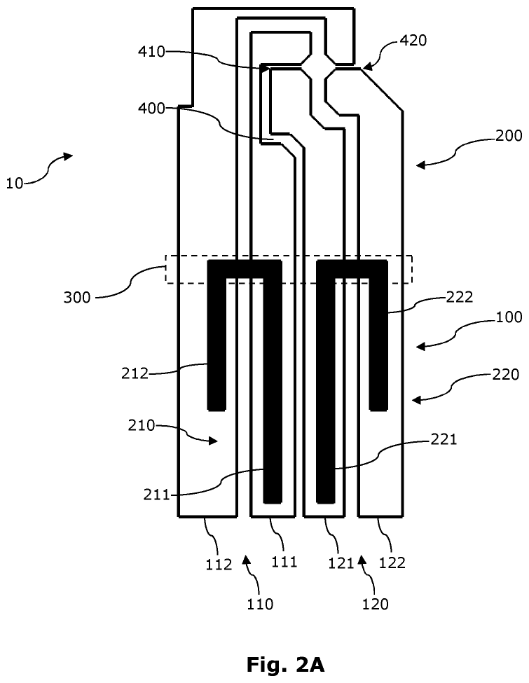

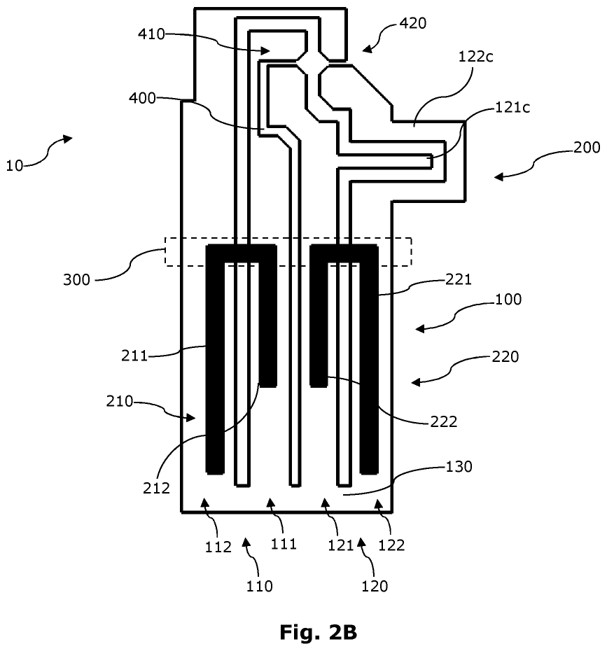

The feeding structure, which is shown in more detail in FIG. 2A is centered between the first radiator arm 21a and the second radiator arm 21b of the first radiator 21 and between the first radiator arm 22a and the second radiator arm 22b of the second radiator 22. Accordingly, a very symmetric setup is achieved.

The feeding structure 10 includes a first conductive plane 100 and a second conductive plane 200. The first and second conductive planes 100, 200 are oriented substantially parallel to each other and are conductive planes of the same PCB 500. The first and second conductive planes 100, 200 are separated by an insulating layer (not shown) of the PCB 500.

The first conductive plane 100 comprises a first pair 110 of balanced conductor elements 111, 112 (fingers) and a second pair 120 of balanced conductor elements 121, 122 fingers. The first radiator 21 is conductively connected (e.g. soldered) to the first pair 110 of balanced conductor elements 111, 112 at a first radiator connection end 410 and the second radiator 22 is conductively connected (e.g. soldered) to the second pair 120 of balanced conductor elements 121, 122 at a second radiator connection end 420.

The first pair 110 of balanced conductor elements 111, 112 provides a balanced output for the first radiator 21 of the dual polarized radiator 20. Accordingly, the second pair of balanced conductor elements provides a balanced output for the second radiator 22 of the dual polarized radiator 20.

The second conductive plane 200, comprises a first unbalanced conductor element 210 and a second unbalanced conductor element 220. Each one of the unbalanced conductor elements 210, 220 has a first branch 211; 221 and a second branch 212; 222. The second branch 212; 222 is conductively connected to the respective first branch 211; 221 at a feeding point 300 (encircled with dashed line) of the feeding structure 10.

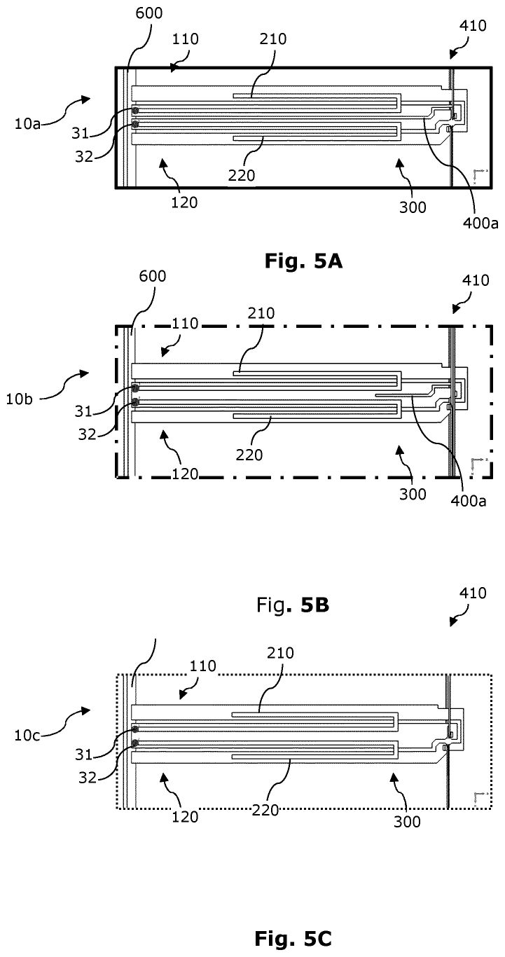

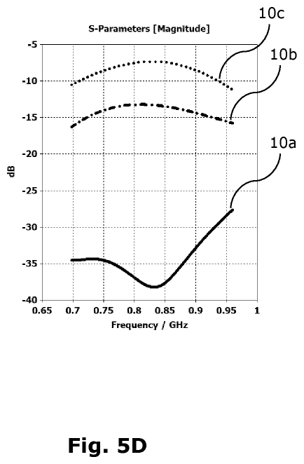

The first branches 211; 221 are input branches, being adapted to being conductively connected to a respective unbalanced signal input line 31; 32 (cf. FIGS. 5A to 5C), which may be provided on a feed PCB 600. The second branches 212; 222 are open branches, ending at an open end 212′, 222′.

Depending on the radiator design and feeding point position, the first branch 211, 221 and second branch 212, 222 may have together a length of λ/4 or at least one by oneself λ/4.

In case of the second branches 212, 222 have a length of λ/4 from the feeding point 300 to its open end 221′, 222′ (open stub length=λ/4), the open stub may be replaced by a short close to the feeding point 300.

The first branch 211 of the first unbalanced conductor element 210 is assigned to (broadside coupled) the first balanced conductor element 111 of the first pair 110 of balanced conductor elements and the second branch 212 of the first unbalanced conductor element 210 is assigned to (broadside coupled) the second balanced conductor element 112 of the first pair 110 of balanced conductor elements, so as to form a first Marchand balun assigned to the first pair 110 of balanced conductor elements 111, 112.

Accordingly, the first branch 221 of the second unbalanced conductor element 220 is assigned to the first balanced conductor element 121 of the second pair 120 of balanced conductor elements and the second branch 222 of the second unbalanced conductor element 220 is assigned to a second balanced conductor element 122 of the second pair 120 of balanced conductor elements, so as to form a second Marchand balun assigned to the second pair 120 of balanced conductor elements 121, 122.

Due to the Marchand baluns, the unbalanced input signal of the first branches 211, 221 of the first/second unbalanced conductor elements 210, 220 is converted to a balanced input signal, guided via the respective balanced conductor elements 111, 112, 121, 122 to the radiators 21, 22. For example, balanced conductor element 112 may have a phase shift of 180°, balanced conductor element 111 may have a phase shift of 0°, balanced conductor element 121 may have a phase shift of 0° and balanced conductor element 122 may have a phase shift of 180°.

Further, a slot 400 is formed between the first pair 110 of balanced conductor elements 111, 112 and the second pair 120 of balanced conductor elements 121, 122. The slot 400 extends from the first and second radiator connection ends 410, 420 to the start of the of balanced conductor elements 111, 112, 121, 122 and separates the first and second pairs 110, 120 of balanced conductor elements.

The first radiator connection end 410 and the second radiator connection end 420 are provided on opposing sides of a dual polarized radiator 20 to be fed. As best seen in FIG. 2A, the first radiator connection end 410 of the first pair of balanced conductor elements 111, 112 is provided on an upper side of the dual polarized radiator 20, wherein the second radiator connection end 420 of the second pair of balanced conductor elements 121, 122 is provided on a lower side of the dual polarized radiator 20.

For bridging a gap provided between the first and second arms 21a, 21b of the first radiator 21, a via 111v is provided in conductor element 111. Accordingly, balanced conductor element 111 starts on the first conductive plane 100 and is continued on the second conductive plane 200. Accordingly, the gap between the first and second arms 22a, 22b of the second radiator 22 is bridged by using a via in conductor element 122. Hence, balanced conductor element 122 starts on the first conductive plane 100 and is continued on the second conductive plane 200.

The first pair 110 of balanced conductor elements 111, 112 is penetrating the radiator and extends over the radiator. The second pair 120 of balanced conductor elements 121, 122 is not penetrating the radiator.

The first radiator connection end 410 and the second radiator connection end 420 overlaps in the vertical plane mainly with the second pair 120 of balanced conductor elements 121, 122.

FIG. 2B shows a schematic illustration of an alternative feeding structure 10 for the dual polarized radiator 20 of FIG. 1. Compared to the feeding structure 10 of FIG. 2A, the unbalanced conductor elements are differently arranged. As shown, the second open branches 212, 222 are now arranged side by side in the middle and are sandwiched by the outer first branches 211, 221. Accordingly, in the feeding structure shown in FIG. 2B, the balanced conductor element 112 may have a phase shift of 0°, balanced conductor element 111 may have a phase shift of 180°, balanced conductor element 121 may have a phase shift of 180° and balanced conductor element 122 may have a phase shift of 0°.

Further, in the embodiment shown in FIG. 2B the slot separating the first and second pairs 110, 120 of balanced conductor elements 111, 112, 121, 122 extends from the first and second radiator connection end 410, 420 along the length of the first unbalanced conductor elements 111, 121. All balanced conductor elements 111, 112, 121, 122 have a common base conductive part 130, connecting the balanced conductor elements of the first pair 110 and the second pair 120.

Further balanced conductor elements 121 and 122 of the second pair 120 of balanced conductor elements each include an electrical length compensation element 121c, 122c. Those electrical length extension elements 121c, 122c extend the length of the of the balanced conductor elements 121, 122 artificially, and allow to compensate for length differences between the first and second pair of balanced conductor elements 110, 120. Here, the difference in length is caused as first radiator connection end 410 of the first pair 110 of balanced conductor elements 111, 112 is provided on an upper side of the dual polarized radiator 20, wherein the second radiator connection end 420 of the second pair 120 of balanced conductor elements 121, 122 is provided on a lower side of the dual polarized radiator 20. With providing the electrical length extension elements 121c, 122c particularly the slots separating the balanced conductor elements 111, 112; 121, 122 of each pair 110, 120 of balanced conductor elements can be provided having the same length.

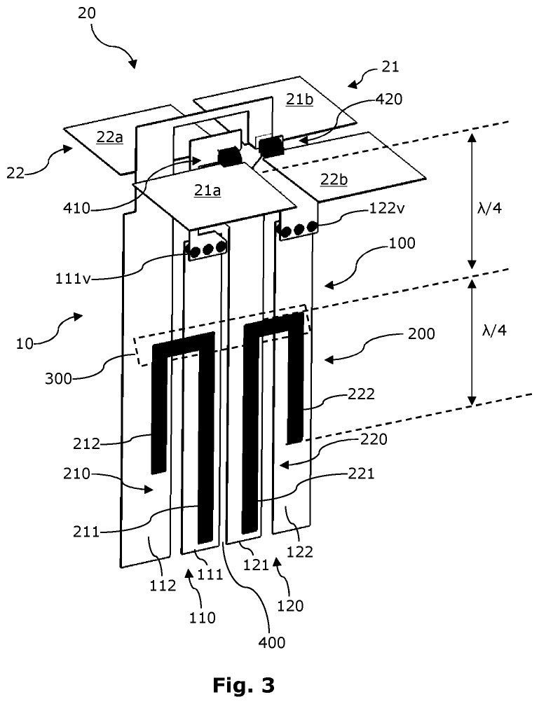

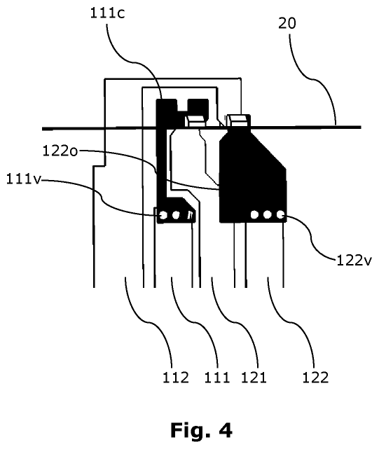

FIG. 3 gives a schematic illustration of a further dual polarized radiator 20, including a further feeding structure 10. The feeding structure 10 of FIG. 3 includes particularly the same elements described above with reference to FIGS. 1, 2A and 2B, however, the first and second radiator connection ends 410, 420 are formed differently. A more detailed view is given in FIG. 4.

According to this aspect, the first radiator connection end 410 and the second radiator connection end 420 are provided on the same side of the dual polarized radiator 20, namely on a side of a dual polarized radiator 20 that faces away from the feeding point 300. Hence, the first radiator connection end 410 and the second radiator connection 420 are provided on an upper side of the dual polarized radiator 20 allowing e.g. a selective wave soldering method for connecting the feeding structure 10 to the dual polarized radiator 20.

Here, (as in FIGS. 1, 2A and 2B) no vias are provided in the unbalanced first and second conductor elements 210, 220. However, the first balanced conductor element 111 of the first pair 110 of balanced conductor elements as well as the second balanced conductor element 122 of the second pair 120 of balanced conductor elements each include at least one via 111v, 122v. Accordingly, the balanced conductor elements 111, 122 are partially arranged on the second conductive plane 200, at least at the respective radiator connection ends 410, 420.

With providing said vias 111v, 122v the balanced conductor elements 111, 122 start on the first conductive plane 100 and are then continued on the second conductive plane 200. This allows to connect opposing arms 21a, 21b; 22a, 22b of the first and second radiators 21, 22 easily, as the gap formed between these arms 21a, 21b; 22a, 22b can be bridged by the via(s).

In FIG. 3, the first balanced conductor element 111 of the first pair 110 is connected to the first arm 21a of the first radiator 21. The second balanced conductor element 112 of the first pair 110 is connected to the second arm 21b of the first radiator 21. The first balanced conductor element 121 of the second pair 120 is connected to the first arm 22a of the second radiator 22. The second balanced conductor element 122 of the second pair 120 is connected to the second arm 22b of the second radiator 22.

In FIG. 4, a further optional detail is shown. The second balanced conductor element 122 includes an additional overlap element 1220, being arranged on the second conductive plane 200. The additional overlap element 1220 is formed as a portion of the balanced conductor element 122 that overlaps (but is not electrically connected to) balanced conductor element 121 (broadside coupling). This allows to adjust the phase shift between conductor elements 121, 122.

FIG. 5A shows schematic details of the feeding structure 10a including a long slot 400a, extending from the first and second radiator connection ends 410, 420 through the entire feeding structure to the feed PCB 600.

In the feeding structure 10b shown in FIG. 5B, the slot 400b is modified (shortened) and just goes slightly beyond the feeding point 300, starting from the first and second radiator connection ends 410, 420. In the feeding structure shown in FIG. 5C, the slot is omitted.

FIG. 5D is a graph measured for the feeding structures according to FIGS. 5A to 5C. The solid line, denoted with 10a, corresponds to the feeding structure 10a, shown in FIG. 5A. The dot dash line, denoted with 10b, corresponds to the feeding structure 10b, shown in FIG. 5B and the dotted line, denoted with 10c, corresponds to the feeding structure 10c, shown in FIG. 5C.

As will become apparent, the feeding structure 10a having the long slot 400a has a significantly improved port to port isolation of at least 25 dB over the entire frequency range investigated, i.e. from about 0.7 GHZ to about 0.95 GHz.

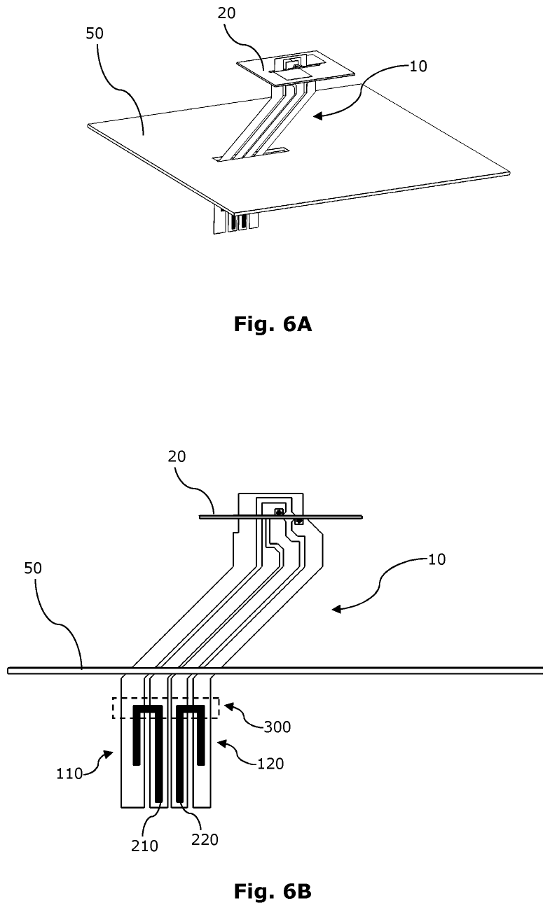

FIGS. 6A and 6B schematically show a dual polarized radiator 20 including a feeding structure 10 and a reflector 50. The feeding structure 10 penetrates the reflector 50 and is positioned so that the first unbalanced conductor element 210 and a second unbalanced conductor element 220 (and accordingly the Marchand baluns as well as the feeding point 300) are arranged on a side of the reflector 50 facing away from the dual polarized radiator 20.

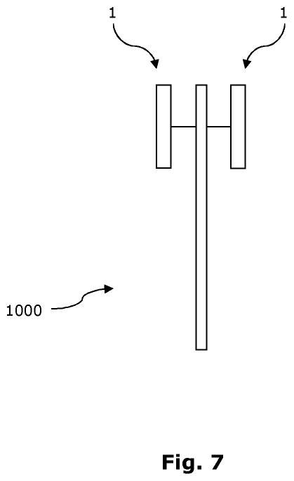

FIG. 7 shows schematically a base station 1000 comprising two base station antennas 1, wherein each base station antenna may include a dual polarized radiator as explained above with respect to any one of FIGS. 1 to 6B.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

### LIST OF REFERENCE SIGNS

1 base station antenna
10 feeding structure
10a feeding structure
10b feeding structure
10c feeding structure
20 dual polarized radiator
21 first radiator
21a first radiator arm of first radiator
21b second radiator arm of first radiator
22 second radiator
22a first radiator arm of second radiator
22b second radiator arm of second radiator
31 signal input line
32 signal input line
50 reflector
100 first conductive plane
110 first pair
111 balanced conductor element
111v via
111c electrical length compensation element
112 balanced conductor element
120 second pair
121 balanced conductor element
121c electrical length compensation element
122 balanced conductor element
122c electrical length compensation element
1220 additional overlap element
122v via
130 common base conductive part
200 second conductive plane
210 unbalanced conductor element
211 first branch
212 second branch
212′ open end
220 unbalanced conductor element
221 first branch
222 second branch
222′ open end
300 feeding point
400 slot
400a slot
400b slot
410 first radiator connection end
420 second radiator connection end
500 PCB
600 Feed PCB
1000 base station
λ wavelength of dual polarized radiator

1. A feeding structure for a dual polarized radiator, particularly for a base station antenna, the feeding structure comprising:
a first conductive plane and a second conductive plane;
the first conductive plane comprising a first pair of balanced conductor elements and a second pair of balanced conductor elements;
wherein the first pair of balanced conductor elements provides a balanced output and is adapted to being connected to a first radiator of a dual polarized radiator with a first radiator connection end; and
wherein the second pair of balanced conductor elements provides a balanced output and is adapted to being connected to a second radiator of the dual polarized radiator with a second radiator connection end;
the second conductive plane, comprising a first unbalanced conductor element and a second unbalanced conductor element;
each one of the unbalanced conductor elements having a first branch and a second branch, the second branch being conductively connected to the respective first branch at a feeding point of the feeding structure;
wherein the first branches are input branches, being adapted to being conductively connected to a respective unbalanced signal input line;
the first branch of the first unbalanced conductor element is assigned to a first balanced conductor element of the first pair of balanced conductor elements and the second branch of the first unbalanced conductor element is assigned to a second balanced conductor element of the first pair of balanced conductor elements, so as to form a first Marchand balun assigned to the first pair of balanced conductor elements; and
wherein the first branch of the second unbalanced conductor element is assigned to a first balanced conductor element of the second pair of balanced conductor elements and the second branch of the second unbalanced conductor element is assigned to a second balanced conductor element of the second pair of balanced conductor elements, so as to form a second Marchand balun assigned to the second pair of balanced conductor elements;
wherein a slot is formed between the first pair of balanced conductor elements and the second pair of balanced conductor elements, the slot extending from the first and/or second radiator connection end for separating the first and second pairs of balanced conductor elements at least along a portion of the length of the balanced conductor elements.

2. The feeding structure according to claim 1, wherein the second branches are open branches, or wherein the second branches are connected to ground.

3. The feeding structure according to claim 1, wherein the first and second conductive planes are oriented substantially parallel to each other.

4. The feeding structure according to claim 1, wherein at least one of the first and/or second conductive planes is a conductive plane of a PCB, and wherein the first and second conductive planes may be conductive planes of the same PCB, wherein the PCB is a multilayer PCB or a dual layer PCB.

5. The feeding structure according to claim 1, wherein at least one of the first and/or second conductive planes is a sheet metal plane.

6. The feeding structure according to claim 1, wherein the first and second conductive planes sandwich an insulator layer, wherein the first and second conductive layers are fixedly adhered to the insulator layer.

7. The feeding structure according to claim 1, wherein the slot extends from the first and/or second radiator connection end at least to the feeding point, optionally at least along the length of the first unbalanced conductor element and/or the second unbalanced conductor element, and further optionally entirely separates the first conductive plane.

8. The feeding structure according to claim 1, wherein the slot extends through the entire feeding structure in a direction perpendicular to the first conductive plane.

9. The feeding structure according to claim 1, wherein:
the first radiator connection end and the second radiator connection end are provided on opposing sides of a dual polarized radiator to be fed, and
the first radiator connection end and the second radiator connection end are provided on the same side of a dual polarized radiator to be fed, wherein the first radiator connection end and the second radiator connection end may be arranged on a side of a dual polarized radiator that faces away from the feeding point.

10. The feeding structure according to claim 1, wherein at least one of the first and second pair of balanced conductor elements penetrates the radiator and extends over the radiator;
one of the first and second pair of balanced conductor elements penetrates the radiator and extends over the radiator more than the other pair of balanced conductor elements; and
the first pair of balanced conductor elements extends more over the radiator while the second pair of balanced conductor elements overlaps in a vertical plane more than the first pair of balanced conductor elements with the first radiator connection end and the second radiator connection end.

11. The feeding structure according to claim 1, wherein no vias are provided in the unbalanced first and second conductor elements.

12. The feeding structure according to claim 1, wherein:
the first or second balanced conductor element of the first pair of balanced conductor elements includes at least one via, so that this balanced conductor element of the first pair of conductor elements is partially arranged on the second conductive plane, at least at the first radiator connection end; and
the first or second balanced conductor element of the second pair of balanced conductor elements includes at least one via, so that this balanced conductor element of the second pair of conductor elements is partially arranged on the second conductive plane, at least at the second radiator connection end.

13. The feeding structure according to claim 12, wherein the at least one via, and optionally all vias assigned to the balanced conductor elements are arranged on a side of the dual polarized radiator to be fed, that faces the feeding point.

14. The feeding structure according to claim 1, wherein the first radiator connection end and the second radiator connection end are adapted to be soldered or welded to respective radiators.

15. The feeding structure according to claim 1, wherein one of the balanced conductor elements of a respective pair of balanced conductor elements includes an electrical length compensation element and/or an additional overlap element.

16. The feeding structure according to claim 1, wherein:
the first branches of the first unbalanced conductor element and the second unbalanced conductor element are arranged side by side; and
the second branches of the first unbalanced conductor element and the second unbalanced conductor element are arranged side by side.

17. The feeding structure according to claim 1, wherein:
the first branch of the first unbalanced conductor element extends along and overlaps the first balanced conductor element of the first pair of balanced conductor elements;
the second branch of the first unbalanced conductor element extends along and overlaps the second balanced conductor element of the first pair of balanced conductor elements;
the first branch of the second unbalanced conductor element extends along and overlaps the first balanced conductor element of the second pair of balanced conductor elements; and
the second branch of the second unbalanced conductor element extends along and overlaps the second balanced conductor element of the second pair of balanced conductor elements.

18. A dual polarized radiator including the feeding structure according to claim 1, the dual polarized radiator further including:
a first radiator, particularly a first dipole, and a second radiator, particularly a dipole;
wherein the first radiator is conductively connected to the first pair of balanced conductor elements; and
wherein the second radiator is conductively connected to the second pair of balanced conductor elements.

19. The dual polarized radiator according to claim 18, wherein the first and second radiators are PCB radiators or sheet metal radiators.

20.-25. (canceled)

26. A base station antenna for wireless communication, the base station antenna including:
at least one dual polarized radiator including the feeding structure according to claim 1, the dual polarized radiator further including:
a first radiator, particularly a first dipole, and a second radiator, particularly a dipole;
wherein the first radiator is conductively connected to the first pair of balanced conductor elements; and
wherein the second radiator is conductively connected to the second pair of balanced conductor elements; and
optionally a phase shifter for adapting the beam direction of the base station antenna.
